(19) United States
(12) Patent Application Publication
(10) Pub. No.: US 2025/0236335 A1
(43) Pub. Date: Jul. 24, 2025

(54) STEERING SYSTEM

(71) Applicant: TOYOTA JIDOSHA KABUSHIKI KAISHA, Aichi-ken (JP)

(72) Inventors: Yoshio KUDO, Tokyo (JP); Hidetsugu TOYAMA, Susono-shi (JP)

(21) Appl. No.: 18/976,330

(22) Filed: Dec. 11, 2024

(30) Foreign Application Priority Data
Jan. 18, 2024 (JP) 2024-006356

(51) Int. Cl. B62D 6/00; B62D 5/00

(52) U.S. Cl. CPC B62D 6/008; B62D 5/006

(57) ABSTRACT

A steering system includes: an operation device including an operation member and a reaction force applying device that applies an operation reaction force to the operation member; a steering operation device that is mechanically separated from the operation device and steers a wheel according to a steering current supplied; and a controller that controls the steering operation device and the reaction force applying device based on an operation signal received from the operation device and related to operation of the operation member. The steering system is configured to switch a normal mode in which the wheel is steered based on the operation signal and a virtual mode in which a virtual moving object is steered based on the operation signal. The controller is configured to, in the virtual mode, set the steering current to a current value at which the wheel is not steered regardless of the operation signal.

### CROSS-REFERENCE TO RELATED APPLICATION

This application claims priority to Japanese Patent Application No. 2024-006356 filed on Jan. 18, 2024, incorporated herein by reference in its entirety.

### BACKGROUND

### 1. Technical Field

The present disclosure relates to a steering system.

### 2. Description of Related Art

In the field of a steer-by-wire steering system in which an operation member and a steering operation device are mechanically separated, there has recently been developed a steering system configured to enable a user to play a game using the operation member, for example, during charging of a battery electric vehicle. For example, Japanese Unexamined Patent Application Publication No. 2022-1925 (JP 2022-1925 A) discloses a vehicle in which an object to be operated by an operation unit of a steering device can be switched between the vehicle and a virtual moving object in a game. That is, such a steering system is configured to switch a normal mode in which the vehicle is operated and a game mode in which the virtual moving object is operated.

### SUMMARY

The steer-by-wire steering system is configured such that, when the operation member is operated by a user, a reaction force applying device applies an operation reaction force to the operation member in response to movement of the operation member. Since the vehicle is not actually traveling in the game mode, control inappropriate to the situation may be performed when the same control as in the normal mode is applied to the game mode.

The present disclosure provides a steering system capable of performing control appropriate for use of an operation member in a game.

A steer-by-wire steering system according to a first aspect of the present disclosure includes: an operation device including an operation member for steering operation by a user and a reaction force applying device configured to apply an operation reaction force to the operation member; a steering operation device that is mechanically separated from the operation device and is configured to steer a wheel according to a steering current supplied; and a controller configured to control the steering operation device and the reaction force applying device based on an operation signal received from the operation device and related to operation of the operation member. The steering system is configured to switch a normal mode in which the wheel is steered based on the operation signal and a virtual mode in which a virtual moving object created as an image is steered based on the operation signal. The controller is configured to, in the virtual mode, set the steering current to a current value at which the wheel is not steered regardless of the operation signal.

In the steering system according to the first aspect of the present disclosure, the controller may be configured to set the steering current to zero in the virtual mode regardless of the operation signal.

In the steering system according to the first aspect of the present disclosure, the controller may be configured to use a plurality of calculation terms and a plurality of gains in calculation of the current value of the steering current, and set the calculation terms to zero or set the gains to zero in the virtual mode.

In the steering system according to the first aspect of the present disclosure, the controller may be configured to receive a steered angle signal related to a steered angle of the wheel from the steering operation device, calculate a first term based on an angle difference between a target steered angle corresponding to the operation signal and an actual steered angle corresponding to the steered angle signal and based on a predetermined first gain, calculate a second term based on a derivative difference between a time derivative of the target steered angle and a time derivative of the actual steered angle and based on a predetermined second gain, calculate a third term based on the derivative difference and a predetermined third gain, and calculate a steering torque command value corresponding to the steering current based on a value obtained by subtracting the third term from a sum of the first term and the second term. The controller may be configured to, in the virtual mode, (i) set the first term, the second term, and the third term to zero, (ii) set the predetermined first gain, the predetermined second gain, and the predetermined third gain to zero, (iii) set the steering torque command value to zero, or (iv) set the target steered angle to a predetermined constant value.

In the steering system according to the first aspect of the present disclosure, the controller may be configured to receive a steered angle signal related to a steered angle of the wheel from the steering operation device, add, to a calculation value of the operation reaction force that is calculated based on the operation signal, a compensation torque value set to increase as an angle difference between a target steered angle corresponding to the operation signal and an actual steered angle corresponding to the steered angle signal increases, and in the virtual mode, set the compensation torque value to a predetermined torque value regardless of the angle difference.

In the steering system according to the first aspect of the present disclosure, the predetermined torque value may be zero.

In the steering system according to the first aspect of the present disclosure, the steering operation device may include a current sensor configured to detect the steering current. The controller may be configured to, when calculating a virtual axial force value to be included in the operation reaction force, calculate a current axial force value based on a detection value from the current sensor, calculate an angle axial force value based on a sum of a first axial force value based on a vehicle speed and the target steered angle and a second axial force value corresponding to the operation reaction force when the vehicle speed is equal to or lower than a predetermined speed, and, by using a first ratio and a second ratio that are set to have a sum of 1, calculate the virtual axial force value by adding a value obtained by multiplying the angle axial force value by the second ratio to a value obtained by multiplying the current axial force value by the first ratio. The first ratio may be set based on the vehicle speed and the steered angle signal. The controller may be configured to, in the virtual mode, set the first ratio and the second axial force value to zero, and set the vehicle speed for use in calculation of the first axial force value to a predetermined value.

In the steering system according to the first aspect of the present disclosure, the steering operation device may include a current sensor configured to detect the steering current. The controller may be configured to receive an accelerator signal related to operation of an accelerator operation member for operating an accelerator provided to a vehicle, and a brake signal related to operation of a brake operation member for operating a brake provided to the vehicle, and when calculating a virtual axial force value to be included in the operation reaction force, calculate a current axial force value based on a detection value from the current sensor, calculate an angle axial force value based on a sum of a first axial force value based on a vehicle speed and the target steered angle and a second axial force value corresponding to the operation reaction force when the vehicle speed is equal to or lower than a predetermined speed, and, by using a first ratio and a second ratio that are set to have a sum of 1, calculate the virtual axial force value by adding a value obtained by multiplying the angle axial force value by the second ratio to a value obtained by multiplying the current axial force value by the first ratio. The first ratio may be set based on the vehicle speed and the steered angle signal. The controller may be configured to, in the virtual mode, set the vehicle speed for use in calculation of the first axial force value, the first ratio, and/or the second axial force value based on the accelerator signal or the brake signal.

According to the present disclosure, in the virtual mode, the steering current to be supplied to the steering operation device is set to the current value (e.g., zero) at which the wheel is not steered. Therefore, unnecessary steering of the wheel caused by the operation of the operation member is suppressed, and deterioration of a tire and power consumption are suppressed. That is, according to the present disclosure, it is possible to perform control appropriate for use of the operation member in the game.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a configuration diagram of a steering system according to an embodiment;

FIG. 2 is a conceptual diagram illustrating steering control and reaction force control according to the embodiment;

FIG. 3 is a conceptual diagram illustrating the reaction force control according to the embodiment;

FIG. 4 is a conceptual diagram illustrating a difference in operation reaction force between a case where a vehicle is traveling and a case where the vehicle is stopped according to the embodiment; and

FIG. 5 is a flowchart showing a flow of control mode changing according to the embodiment.

### DETAILED DESCRIPTION OF EMBODIMENTS

As a mode for carrying out the present disclosure, a steering system 1 according to an embodiment of the present disclosure will be described in detail below with reference to the drawings. The present disclosure can be carried out in various modes with various modifications and improvements based on the knowledge of those skilled in the art in addition to the embodiment described below. The steering system 1 of the present embodiment is mounted on, for example, a battery electric vehicle. Communications in the 10 vehicle are performed, for example, by a controller area network (CAN), FlexRay, Ethernet, etc.

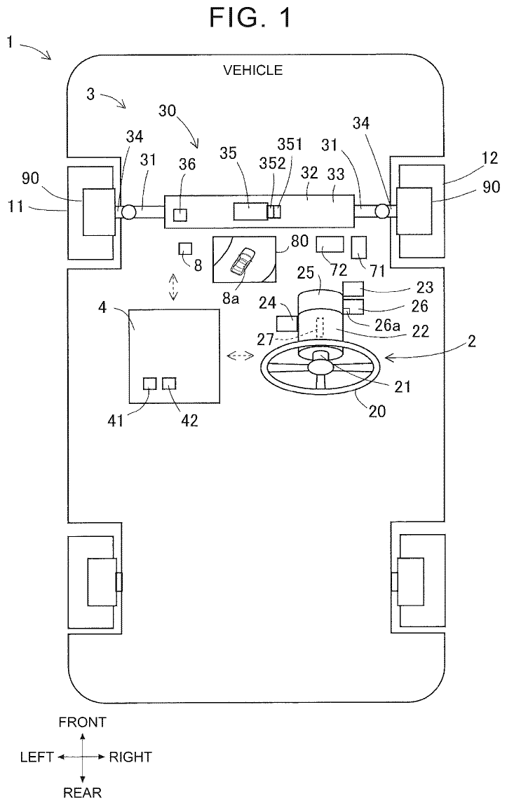

As shown in FIG. 1, the steering system 1 includes an operation device 2, a steering operation device 3, and a controller 4. The operation device 2 of the present embodiment includes an operation member 20, a steering shaft 21, a steering column 22, an operation amount sensor 23, an operation torque sensor 24, and a reaction force applying device 25.

The operation member 20 is a handling member for steering operation by a user. The operation member 20 is, for example, a steering wheel. The shape of the operation member 20 is not limited to a circular shape like the steering wheel, but may be a polygonal shape such as a quadrangular shape. The operation member 20 can also be regarded as a steering operation member. The operation member 20 is fixed to the tip of the steering shaft 21. The operation member 20 and the steering shaft 21 are rotatably held on an instrument panel reinforcement by the steering column 22.

The operation amount sensor 23 detects an operation amount (operation angle) of the operation member 20. The operation torque sensor 24 detects an operation torque of the operation member 20. The operation torque can also be regarded as an operation force applied to the operation member 20 by the user. The operation torque sensor 24 detects, for example, a torsion amount of a torsion bar 27 incorporated in the steering shaft 21.

The reaction force applying device 25 applies an operation reaction force to the operation member 20. The reaction force applying device 25 includes a reaction force motor 26 that is an electric motor. The reaction force applying device 25 uses the reaction force motor 26 supported by the steering column 22 as a power source to apply an operation reaction force against a steering operation to the operation member 20 via the steering shaft 21. The reaction force applying device 25 has a general structure including a speed reducer etc. The reaction force motor 26 is provided with a rotation angle sensor 26a.

The steering operation device 3 steers wheels 11, 12 (front wheels or steered wheels). The steering operation device 3 is mechanically separated from the operation device 2. The steering operation device 3 includes a steering motor 35 that is an electric motor serving as a drive source, and a current sensor 351 that detects a current value of a steering current input to the steering motor 35. More specifically, the steering operation device 3 includes a steering rod 31, a housing 32, a rod moving mechanism 33, the steering motor 35, the current sensor 351, a rotation angle sensor 352, and a steered angle sensor 36.

The steering rod 31 is a member having two ends connected to right and left steering knuckles 90 via tie rods 34. The housing 32 is a member that supports the steering rod 31 so that the steering rod 31 is movable laterally, and is fixedly held on a vehicle body.

The rod moving mechanism 33 laterally moves the steering rod 31 using the steering motor 35 as a drive source. The steering motor 35 is an electric motor that steers the wheels 11, 12. The rod moving mechanism 33 is mainly composed of a ball screw mechanism that includes a ball groove threaded in the steering rod 31 and a nut engaged with the ball groove via bearing balls and rotated by the steering motor 35. Since the rod moving mechanism 33 has a general structure, detailed description thereof will be omitted.

The current sensor 351 detects a current value of a control current (i.e., a steering current) input to the steering motor 35. The rotation angle sensor 352 detects a rotation angle of the steering motor 35. The steered angle sensor 36 detects a steered angle (steered amount) of the wheels 11, 12. The steered angle sensor 36 detects the amount of movement of the steering rod 31 to the right or left from a neutral position.

The controller 4 controls the steering operation device 3 and the reaction force applying device 25 based on an operation signal received from the operation device 2 and related to the operation of the operation member 20. The controller 4 receives a steered angle signal related to the steered angle of the wheels 11, 12 from the steering operation device 3, that is, a detection value from the steered angle sensor 36. It can be said that the controller 4 controls the steering operation device 3 and the reaction force applying device 25 based on the operation signal and the steered angle signal.

The controller 4 is a computer including one or more processors 41 and one or more memories 42. The computer can also be regarded as an electronic control unit (ECU). The controller 4 is communicatively connected to the operation device 2 and the steering operation device 3. The operation device 2 and the steering operation device 3 are electrically connected via the controller. That is, the steering system 1 is a steer-by-wire steering system that steers the vehicle by converting a mechanical operation on the operation member 20 by the user into an electric signal and transmitting the electric signal to the steering operation device 3 that is mechanically separated from the operation member 20. The controller 4 may be composed of two or more computers communicatively connected to each other. For example, the controller 4 may be composed of a controller (computer) for the operation device 2 and a controller (computer) for the steering operation device 3.

### Control Modes

The steering system 1 is configured to switch a normal mode in which the wheels 11, 12 are steered based on an operation signal and a virtual mode in which a virtual moving object 8a created as an image is steered based on an operation signal. That is, at least two control modes are set in the steering system 1. The normal mode is a control mode for steering the vehicle based on the operation of the operation member 20. The virtual mode is, for example, a control mode in which the virtual moving object 8a (e.g., an image of a vehicle) depicted as an image in a game is operated with the operation member 20. The virtual moving object 8a is created as an image that can be viewed in the vehicle. The normal mode can also be regarded as, for example, a first mode, a main mode, or a real mode. The virtual mode can also be regarded as, for example, a second mode, a sub-mode, or a game mode.

A display device 80 is disposed in the vehicle. Examples of the display device 80 include an instrument panel display, a navigation system display, a windshield to which images etc. are projected, a mobile terminal display, augmented reality (AR) glasses, and a head-mounted display. A gaming machine 8 may be disposed inside the vehicle, or may be disposed outside the vehicle by being connected to the vehicle by wireless communication. The gaming machine 8 can be regarded as a computer including one or more processors and one or more memories. The gaming machine 8 and the controller 4 are connected to communicate only predetermined information.

In the virtual mode, the gaming machine 8 displays the virtual moving object 8a on the display device 80. The controller 4 and/or the CAN transmit(s) an operation signal etc. (e.g., operation information that can be read from the operation signal) to the gaming machine 8. The gaming machine 8 creates a display image of the virtual moving object 8a on the display device 80 based on the information received from the vehicle side (e.g., the CAN), and causes the display device 80 to display a situation in which the virtual moving object 8a is being steered. That is, in the virtual mode, the user can steer the virtual moving object 8a displayed on the display device 80 by operating the operation member 20.

The controller 4 switches the normal mode and the virtual mode based on a user's operation (instruction). For example, when the user operates a button on mode selection means (e.g., an operation panel) provided in the vehicle to select the virtual mode, the controller 4 checks whether a predetermined condition is satisfied and then switches the control mode of the vehicle from the normal mode to the virtual mode. Similarly, the controller 4 switches the control mode from the virtual mode to the normal mode based on a user's operation on the operation panel etc. When the user selects the virtual mode and the predetermined condition is satisfied, the controller 4 turns ON a change permission flag. When the user has not selected the virtual mode or when the predetermined condition is not satisfied, the change permission flag is kept OFF. The virtual mode is a control mode under the assumption that the user plays a game using the operation member 20 while the vehicle is stopped, for example, while the battery of the battery electric vehicle is being charged.

### Details of Normal Mode

In the normal mode, the controller 4 controls the steering motor 35 based on a detection value from the operation amount sensor 23 (operation amount or operation angle of the operation member 20). The controller 4 calculates a target steered angle based on the detection value from the operation amount sensor 23, and sets a current value of the steering current based on a difference between the target steered angle and an actual steered angle (detection value from the steered angle sensor 36). The controller 4 supplies the set steering current to the steering motor 35.

In the normal mode, the controller 4 sets an operation reaction force for the operation member 20 based on detection values from the operation amount sensor 23 and the operation torque sensor 24, and controls the reaction force motor 26. The controller 4 supplies, to the reaction force motor 26, a control current (hereinafter also referred to as “reaction force current”) corresponding to the set operation reaction force. In the normal mode, the controller 4 sets the operation reaction force for the operation member 20 to simulate, for example, a power steering system (hereinafter also referred to as “mechanically connected system”) in which the operation member 20 and the steering operation device 3 are mechanically connected.

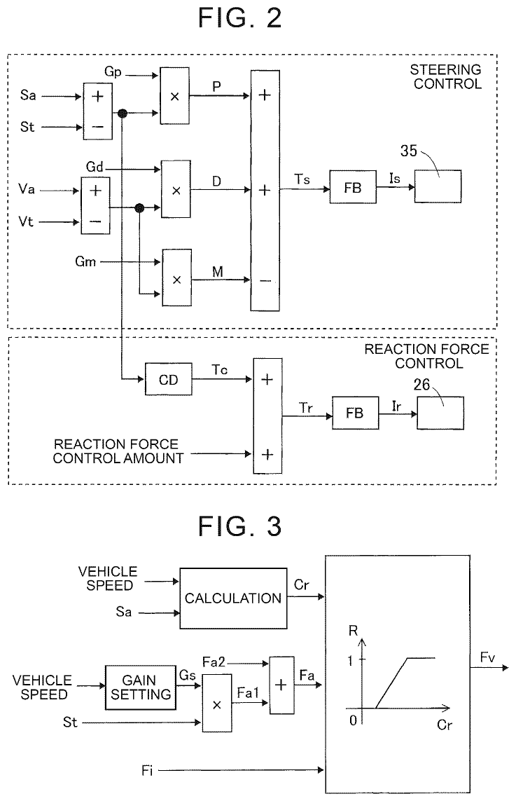

An example of the calculation by the controller 4 will be described. As shown in FIG. 2, in steering control, a deviation term P is calculated by multiplying an angle difference between a target steered angle St and an actual steered angle Sa by a predetermined deviation term gain Gp. A velocity term D is calculated by multiplying, by a predetermined velocity term gain Gd, a velocity difference between a target steered angle velocity Vt that is a value obtained by differentiating the target steered angle St in terms of time and an actual steered angle velocity Va that is a value obtained by differentiating the actual steered angle Sa in terms of time. A damping term M is calculated by multiplying the velocity difference by a damping term gain Gm.

A steering torque command value Ts is calculated by subtracting the damping term M from the sum of the deviation term P and the velocity term D. The deviation term P is a calculation term that increases the steering torque as the angle difference increases. The velocity term D is a calculation term that increases the steering torque as the velocity difference increases. The damping term M is a calculation term for suppressing a sudden change in the steering torque. The steering torque command value Ts is converted into a steering current command value by current feedback control, and a steering current Is corresponding to the steering current command value is supplied to the steering motor 35.

In the above calculation, other calculation terms (e.g., an integral term) for use in known feedback control may be used as the calculation terms. The velocity term D can also be regarded as a differential term. The deviation term P corresponds to a first term, the velocity term D corresponds to a second term, and the damping term M corresponds to a third term. The deviation term gain Gp corresponds to a first gain, the velocity term gain Gd corresponds to a second gain, and the damping term gain Gm corresponds to a third gain.

In reaction force control, a reaction torque command value Tr is calculated by adding a compensation torque value Tc set based on the angle difference to a reaction force control amount set based on the detection value from the operation amount sensor 23 etc. The compensation torque value Tc is set to increase as the angle difference increases. The control for setting the compensation torque value Tc will be referred to as deviation compensation control CD. The compensation torque value Tc is set to inform the user about the magnitude of the angle difference, that is, insufficient follow of the steering motor 35 toward the target steered angle. The compensation torque value Tc is set from the viewpoints of providing information to the user and suppressing operation. The reaction force control amount will be described later. The reaction torque command value Tr is converted into a reaction force current command value by current feedback control FB, and a reaction force current Ir corresponding to the reaction force current command value is supplied to the reaction force motor 26.

An example of the calculation of the reaction force control amount will be described. The reaction force control amount is a value including a separately calculated virtual axial force value Fv. As shown in FIG. 3, the virtual axial force value Fv is calculated based on, for example, a current axial force value Fi and an angle axial force value Fa. The current axial force value Fi is an operation reaction force set based on a change in the steering current. For example, when the vehicle travels on an uneven road surface, the actual steered angle Sa may change to cause an angle difference, and the steering current may change. This is because the steering load changes depending on the road surface condition. The current axial force value Fi is set (calculated) according to such a change in the steering current to inform the user about the road surface condition. The operation reaction force changes in response to the change in the steering current, and thus the user can grasp the road surface condition. The current axial force value Fi can be regarded as a feedback control component, and the angle axial force value Fa can be regarded as a feedforward control component.

The angle axial force value Fa is calculated as the sum of a first axial force value Fa1 and a second axial force value Fa2. The first axial force value Fa1 is calculated by multiplying the target steered angle St by a vehicle speed gain Gs set based on a vehicle speed. The vehicle speed gain Gs is set to increase as the vehicle speed increases. The first axial force value Fa1 increases as the vehicle speed increases and as the target steered angle St increases. It can be said that the first axial force value Fa1 indicates, for example, a force simulating a self-aligning torque felt by a user who operates the operation member in the mechanically connected system.

The first axial force value Fa1 is calculated based on the vehicle speed and the target steered angle St. The first axial force value Fa1 can be regarded as a value corresponding to the operation reaction force when the vehicle speed is higher than a predetermined speed (predetermined speed≥0). The first axial force value Fa1 can also be regarded as a value indicating the operation reaction force when the vehicle is traveling. The second axial force value Fa2 is a value for expressing angle hysteresis when the vehicle is stopped. The second axial force value Fa2 can be regarded as a value corresponding to the operation reaction force when the vehicle speed is equal to or lower than the predetermined speed (predetermined speed≥0). The second axial force value Fa2 can also be regarded as a value indicating the operation reaction force when the vehicle is traveling at an extremely low speed or when the vehicle is stopped. The second axial force value Fa2 can also be regarded as a value for calculating the operation reaction force specific to the case where the vehicle is stopped.

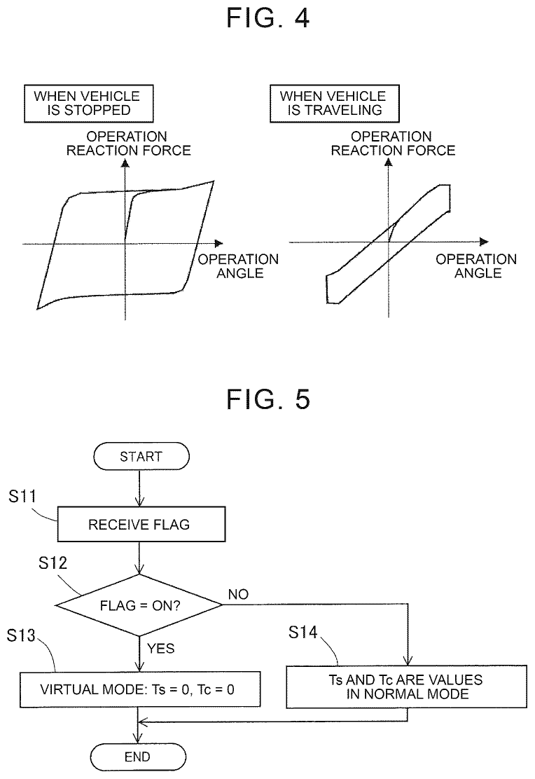

When the user operates the operation member 20 while the vehicle of the mechanically connected system is stopped, a relatively large operation force is required at the initial stage of operation on the operation member 20 due to a frictional force between tires and a road surface. Once the operation member 20 is operated in this state, the operation member 20 is not easily returned to the central position due to the frictional force. The second axial force value Fa2 is a value for simulating, with the operation reaction force, the phenomenon occurring when the vehicle of the mechanically connected system is stopped. As shown in FIG. 4, in order to simulate the mechanically connected system in the normal mode, the reaction force control is designed so that the relationship between the operation reaction force and the operation angle of the operation member 20 varies between the case where the vehicle is stopped (stationary steering) and the case where the vehicle is traveling. The second axial force value Fa2 may be calculated, for example, when the vehicle speed is equal to or lower than the predetermined speed.

The virtual axial force value Fv is calculated by combining the current axial force value Fi and the angle axial force value Fa as shown in Equation (1). A combination ratio R is calculated based on, for example, the vehicle speed and the actual steered angle Sa (0≤R≤1). The vehicle speed is calculated based on, for example, detection values from wheel speed sensors provided to the wheels.

Fv=Fi×R+Fa×(1−R) (1)

The combination ratio R is set so that, for example, the ratio of the current axial force value Fi in the virtual axial force value Fv increases as a calculation value Cr calculated (or set) based on the vehicle speed and the actual steered angle Sa increases. The combination ratio R corresponds to a first ratio, and the ratio (1−R) corresponds to a second ratio. The sum of the first ratio and the second ratio is 1. In this way, the virtual axial force value Fv is a value obtained by combining the current axial force value Fi and the angle axial force value Fa based on the combination ratio R according to the calculation value Cr. It can also be said that the virtual axial force value Fv is calculated based on the vehicle speed, the detection value from the steered angle sensor 36, the detection value from the operation amount sensor 23, and the detection value from the current sensor 351. The reaction force current Ir is set based on the sum of the reaction force control amount including the virtual axial force value Fv and the compensation torque value Tc.

### Details of Virtual Mode

In the virtual mode, the controller 4 sets the steering current to a current value at which the wheels 11, 12 are not steered (i.e., turned) regardless of the operation signal (regardless of the operation of the operation member 20). It can also be said that the controller 4 sets the absolute value of the steering current to a predetermined value or less. For example, in the virtual mode, the controller 4 sets the steering current to zero regardless of the operation signal. That is, the controller 4 is configured not to supply the steering current to the steering motor 35 in principle in the virtual mode. Thus, the steering motor 35 is not operated by the operation signal, and the wheels 11, 12 are not steered. The current value of the steering current at which the wheels 11, 12 are not steered (also referred to as “predetermined current value”) can be calculated in advance by experiments, simulations, etc., assuming, for example, traveling on a general paved or unpaved road.

An example of the process for setting the steering current to the predetermined current value will be described under the assumption that the predetermined current value is set to zero. In the virtual mode, the controller 4 sets the steering torque command value Ts to zero regardless of the values of the deviation term P, the velocity term D, and the damping term M. Thus, the steering current command value is also zero and the steering current Is is also set to zero (see FIG. 2). As another example, the controller 4 may set the values of the deviation term P, the velocity term D, and the damping term M to zero in the virtual mode. As another example, the controller 4 may set the values of the deviation term gain Gp, the velocity term gain Gd, and the damping term gain Gm to zero in the virtual mode. As another example, the controller 4 may set the steering current command value to zero in the virtual mode. The steering current Is can be set to zero through these processes as well. When the predetermined value is a value other than zero, it is preferable, from the viewpoint of ease of calculation, that the controller 4 set the steering torque command value Ts or the steering current command value to a value corresponding to the predetermined current value.

As another example, in the virtual mode, the controller 4 may set the target steered angle to a predetermined angle (constant value) regardless of the operation signal (operation amount or operation angle of the operation member 20). In this case, the calculation terms P, D, M are not output and the steering torque command value Ts is not output. That is, the steering current Is can be set to zero even in this configuration. When the target steered angle velocity is not calculated based on the target steered angle, the controller 4 sets the target steered angle to the predetermined angle and sets the target steered angle velocity to zero in the virtual mode.

When the control mode is switched from the normal mode to the virtual mode and the steering torque command value Ts is set to zero, the controller 4 may gradually reduce the steering torque command value Ts toward zero from the value at the time of switching. That is, the controller 4 may gradually reduce the steering torque command value Ts toward zero from the value in the normal mode immediately before the control mode is switched. Examples of the gradual reduction means include a rate limit, that is, a temporal gradient constraint, and a filtering process that delays the phase of the signal.

In the reaction force control in the virtual mode, the controller 4 sets the compensation torque value Tc to a predetermined torque value regardless of the angle difference. Thus, the compensation torque value Tc that is a component inappropriate to the virtual mode can be controlled to an appropriate value. For example, the predetermined torque value in the present embodiment is zero. That is, in the virtual mode, the controller 4 sets the compensation torque value Tc to zero regardless of the angle difference.

In the reaction force control in the virtual mode, the controller 4 sets the calculation value Cr and the second axial force value Fa2 to zero (see FIG. 3). By setting the calculation value Cr to zero, the component of the current axial force value Fi in the virtual axial force value Fv can be eliminated. The current axial force value Fi is a value that is effective when the vehicle is traveling, that is, a value for the normal mode. Therefore, the current axial force value Fi is unnecessary in the virtual mode as it is. By eliminating this component, the application of the unnecessary operation reaction force is suppressed. In the virtual mode, the controller 4 may set, for example, the vehicle speed to zero so that the calculation value Cr reaches zero.

The second axial force value Fa2 is a value for indicating the difference in the operation reaction force between the case where the vehicle is stopped and the case where the vehicle is traveling as shown in FIG. 4. In most cases in the virtual mode, the operation reaction force when the vehicle is stopped is unnecessary. Therefore, the controller 4 sets the second axial force value Fa2 to zero in the virtual mode, and the angle axial force value Fa is calculated without the second axial force value Fa2. Since the calculation value Cr is zero and the second axial force value Fa2 is zero, the virtual axial force value Fv is a value mainly composed of the first axial force value Fa1 (can also be regarded as a value including only the first axial force value Fa1). That is, the steering system 1 can output an operation reaction force appropriate to the virtual mode.

In the virtual mode, the controller 4 uses a preset value other than zero (also referred to as “predetermined speed”) as the vehicle speed for use in the calculation of the first axial force value Fa1. The controller 4 may vary the predetermined speed depending on an operation amount of an accelerator operation member 71 or an operation amount of a brake operation member 72. The controller 4 receives an accelerator signal related to the operation of the accelerator operation member 71 for operating an accelerator provided to the vehicle, and a brake signal related to the operation of the brake operation member 72 for operating brakes provided to the vehicle. The accelerator signal corresponds to, for example, a detection value from a sensor (not shown) that detects the operation amount of the accelerator operation member 71. The brake signal corresponds to, for example, a detection value from a sensor (not shown) that detects the operation amount of the brake operation member 72.

In the virtual mode, the controller 4 may change the vehicle speed for use in the calculation of the first axial force value Fa1 based on the accelerator signal and/or the brake signal. Thus, the user's accelerator operation and/or brake operation can be reflected in the game. That is, even if the controller 4 cannot receive information on the speed of the virtual moving object 8a from the gaming machine 8, the operation reaction force can be set according to the accelerator operation or the brake operation. In the virtual mode, the controller 4 may set the second axial force value Fa2 to zero only when the accelerator signal is received (0<operation amount). The controller 4 may set the second axial force value Fa2 to the same value as in the normal mode only when the brake signal is received (0<operation amount).

When the controller 4 can receive information on the speed of the virtual moving object 8a from the gaming machine 8 in the virtual mode, the controller 4 may calculate the first axial force value Fa1 and the first ratio R (calculation value Cr) based on the speed information. In this configuration, when the controller 4 receives information indicating that the speed of the virtual moving object 8a is zero, the controller 4 may set the second axial force value Fa2 to the same value as in the normal mode. When the controller 4 can receive information on a lateral acceleration and a yaw rate of the virtual moving object 8a from the gaming machine 8, the controller 4 may calculate the virtual axial force value Fv based on the information.

As an example of the control mode changing, as shown in FIG. 5, the controller 4 receives the change permission flag at a predetermined timing (S11). The predetermined timing may be, for example, a cyclical (periodic) timing or may be a timing after the user performs an operation to change from the normal mode to the virtual mode. When the change permission flag is ON (S12: Yes), the controller 4 sets the control mode to the virtual mode, and sets the steering torque command value Ts and the compensation torque value Tc to zero (S13). At this time, the controller 4 sets the first ratio R and the second axial force value Fa2 to zero. When the change permission flag is OFF (S12: No), the controller 4 sets the control mode to the normal mode, and sets the steering torque command value Ts and the compensation torque value Tc according to the operation signal (S14). The controller 4 calculates the first ratio R and the second axial force value Fa2 in the normal mode.

According to the present embodiment, in the virtual mode, the steering current Is to be supplied to the steering operation device 3 is set to the current value (e.g., zero) at which the wheels 11, 12 are not steered. Therefore, unnecessary steering of the wheels 11, 12 caused by the operation of the operation member 20 is suppressed, and deterioration of the tires and an increase in power consumption are suppressed. That is, according to the present embodiment, it is possible to perform control appropriate for use of the operation member 20 in the game.

In the situation in which the wheels 11, 12 are not steered, the compensation torque value Tc for informing the user about the insufficient follow toward the target steered angle is unnecessary. According to the present embodiment, the compensation torque value Tc included in the operation reaction force in the normal mode is set to zero in the virtual mode. Thus, it is possible to eliminate the unnecessary component in the virtual mode from the operation reaction force, and to avoid output of the operation reaction force that is not expected in the game. That is, according to the present embodiment, it is possible to perform control appropriate for use of the operation member 20 in the game.

The controller 4 of the present embodiment sets the first ratio R and the second axial force value Fa2 to zero. Thus, the operation reaction force that is more appropriate to the virtual mode is set. The gaming machine 8 may function as, for example, a simulator for driving training. The technology of the present disclosure can be applied to a moving object other than the battery electric vehicle. For example, the accelerator operation member 71 and/or the brake operation member 72 may be provided to the operation member 20.

### First Mode

Configuration examples of the present disclosure will be described below. A steering system 1 according to a first mode of the present disclosure includes: an operation device 2 including an operation member 20 for steering operation by a user and a reaction force applying device 25 configured to apply an operation reaction force to the operation member 20; a steering operation device 3 that is mechanically separated from the operation device 2 and is configured to steer wheels according to a steering current supplied; and a controller 4 configured to control the steering operation device 3 and the reaction force applying device 25 based on an operation signal received from the operation device 2 and related to operation of the operation member 20. The steering system 1 is a steer-by-wire steering system configured to switch a normal mode in which the wheels 11, 12 are steered based on the operation signal and a virtual mode in which a virtual moving object 8a created as an image is steered based on the operation signal. The controller 4 is configured to, in the virtual mode, set the steering current to a current value at which the wheels 11, 12 are not steered regardless of the operation signal.

### Second Mode

In a steering system 1 according to a second mode of the present disclosure, in the configuration according to the first mode, the controller 4 is configured to set the steering current to zero in the virtual mode regardless of the operation signal.

### Third Mode

In a steering system 1 according to a third mode of the present disclosure, in the configuration according to the second mode, the controller 4 is configured to use a plurality of calculation terms P, D, M and a plurality of gains Gp, Gd, Gm in calculation of the current value of the steering current Is. The controller 4 is configured to set the calculation terms P, D, M to zero or set the gains Gp, Gd, Gm to zero in the virtual mode.

### Fourth Mode

In a steering system 1 according to a fourth mode of the present disclosure, in the configuration according to the second mode, the controller 4 is configured to receive a steered angle signal related to a steered angle of the wheels 11, 12 from the steering operation device 3. The controller 4 is configured to calculate a deviation term P based on an angle difference between a target steered angle corresponding to the operation signal and an actual steered angle corresponding to the steered angle signal and based on a predetermined deviation term gain Gp. The controller 4 is configured to calculate a velocity term D based on a derivative difference (velocity difference) between a time derivative of the target steered angle and a time derivative of the actual steered angle and based on a predetermined velocity term gain Gd. The controller 4 is configured to calculate a damping term M based on the derivative difference (velocity difference) and a predetermined damping term gain Gm. The controller 4 is configured to calculate a steering torque command value Ts corresponding to the steering current based on a value obtained by subtracting the damping term M from a sum of the deviation term P and the velocity term D. The controller 4 is configured to, in the virtual mode, (i) set the deviation term P, the velocity term D, and the damping term M to zero, (ii) set the deviation term gain Gp, the velocity term gain Gd, and the damping term gain Gm to zero, (iii) set the steering torque command value Ts to zero, or (iv) set the target steered angle to a predetermined constant value.

### Fifth Mode

In a steering system 1 according to a fifth mode of the present disclosure, in the configuration according to one of the first to fourth modes, the controller 4 is configured to receive a steered angle signal related to a steered angle of the wheels 11, 12 from the steering operation device 3, and add, to a calculation value of the operation reaction force that is calculated based on the operation signal, a compensation torque value Tc set to increase as an angle difference between a target steered angle corresponding to the operation signal and an actual steered angle corresponding to the steered angle signal increases. The controller 4 is configured to, in the virtual mode, set the compensation torque value Tc to a predetermined torque value regardless of the angle difference.

### Sixth Mode

In a steering system 1 according to a sixth mode of the present disclosure, in the configuration according to the fifth mode, the predetermined torque value is set to zero.

### Seventh Mode

In a steering system 1 according to a seventh mode of the present disclosure, in the configuration according to one of the first to sixth modes, the steering operation device 3 includes a current sensor 351 configured to detect the steering current. The controller 4 is configured to, when calculating a virtual axial force value Fv to be included in the operation reaction force, calculate a current axial force value Fi based on a detection value from the current sensor 351. The controller 4 is configured to calculate an angle axial force value Fa based on a sum of a first axial force value Fa1 based on a vehicle speed and the target steered angle and a second axial force value Fa2 related to the operation reaction force when the vehicle speed is equal to or lower than a predetermined speed. The controller 4 is configured to, by using a first ratio R and a second ratio (1−R) that are set to have a sum of 1, calculate the virtual axial force value Fv by adding a value obtained by multiplying the angle axial force value Fa by the second ratio (1−R) to a value obtained by multiplying the current axial force value Fi by the first ratio R. The first ratio R is set based on the vehicle speed and the steered angle signal. The controller 4 is configured to, in the virtual mode, set the first ratio R and the second axial force value Fa2 to zero and set the vehicle speed for use in calculation of the first axial force value Fa1 to a predetermined value. The setting of the vehicle speed to the predetermined value corresponds to setting of a vehicle speed gain Gs to a predetermined value.

### Eighth Mode

In a steering system 1 according to an eighth mode of the present disclosure, in the configuration according to one of the first to sixth modes, the steering operation device 3 includes a current sensor 351 configured to detect the steering current. The controller 4 is configured to receive an accelerator signal related to operation of an accelerator operation member 71 for operating an accelerator provided to a vehicle, and a brake signal related to operation of a brake operation member 72 for operating a brake provided to the vehicle. The controller 4 is configured to, when calculating a virtual axial force value Fv to be included in the operation reaction force, calculate a current axial force value Fi based on a detection value from the current sensor 351. The controller 4 is configured to calculate an angle axial force value Fa based on a sum of a first axial force value Fa1 based on a vehicle speed and the target steered angle and a second axial force value Fa2 corresponding to the operation reaction force when the vehicle speed is equal to or lower than a predetermined speed. The controller 4 is configured to, by using a first ratio R and a second ratio (1−R) that are set to have a sum of 1, calculate the virtual axial force value Fv by adding a value obtained by multiplying the angle axial force value Fa by the second ratio (1−R) to a value obtained by multiplying the current axial force value Fi by the first ratio R. The first ratio R is set based on the vehicle speed and the steered angle signal. The controller 4 is configured to, in the virtual mode, set the vehicle speed for use in calculation of the first axial force value Fa1, the first ratio R (vehicle speed for use in the calculation value Cr), and/or the second axial force value Fa2 based on the accelerator signal or the brake signal.

What is claimed is:

1. A steer-by-wire steering system comprising:
an operation device including an operation member for steering operation by a user and a reaction force applying device configured to apply an operation reaction force to the operation member;
a steering operation device that is mechanically separated from the operation device and is configured to steer a wheel according to a steering current supplied; and
a controller configured to control the steering operation device and the reaction force applying device based on an operation signal received from the operation device and related to operation of the operation member, wherein
the steering system is configured to switch a normal mode in which the wheel is steered based on the operation signal and a virtual mode in which a virtual moving object created as an image is steered based on the operation signal, and
the controller is configured to, in the virtual mode, set the steering current to a current value at which the wheel is not steered regardless of the operation signal.

2. The steering system according to claim 1, wherein the controller is configured to set the steering current to zero in the virtual mode regardless of the operation signal.

3. The steering system according to claim 2, wherein the controller is configured to
use a plurality of calculation terms and a plurality of gains in calculation of the current value of the steering current, and
set the calculation terms to zero or set the gains to zero in the virtual mode.

4. The steering system according to claim 2, wherein:
the controller is configured to
receive a steered angle signal related to a steered angle of the wheel from the steering operation device,
calculate a first term based on an angle difference between a target steered angle corresponding to the operation signal and an actual steered angle corresponding to the steered angle signal and based on a predetermined first gain,
calculate a second term based on a derivative difference between a time derivative of the target steered angle and a time derivative of the actual steered angle and based on a predetermined second gain,
calculate a third term based on the derivative difference and a predetermined third gain, and
calculate a steering torque command value corresponding to the steering current based on a value obtained by subtracting the third term from a sum of the first term and the second term; and
the controller is configured to, in the virtual mode, (i) set the first term, the second term, and the third term to zero, (ii) set the predetermined first gain, the predetermined second gain, and the predetermined third gain to zero, (iii) set the steering torque command value to zero, or (iv) set the target steered angle to a predetermined constant value.

5. The steering system according to claim 1, wherein the controller is configured to
receive a steered angle signal related to a steered angle of the wheel from the steering operation device,
add, to a calculation value of the operation reaction force that is calculated based on the operation signal, a compensation torque value set to increase as an angle difference between a target steered angle corresponding to the operation signal and an actual steered angle corresponding to the steered angle signal increases, and
in the virtual mode, set the compensation torque value to a predetermined torque value regardless of the angle difference.

6. The steering system according to claim 5, wherein the predetermined torque value is zero.

7. The steering system according to claim 5, wherein:
the steering operation device includes a current sensor configured to detect the steering current;
the controller is configured to, when calculating a virtual axial force value to be included in the operation reaction force,
calculate a current axial force value based on a detection value from the current sensor,
calculate an angle axial force value based on a sum of a first axial force value based on a vehicle speed and the target steered angle and a second axial force value corresponding to the operation reaction force when the vehicle speed is equal to or lower than a predetermined speed, and
by using a first ratio and a second ratio that are set to have a sum of 1, calculate the virtual axial force value by adding a value obtained by multiplying the angle axial force value by the second ratio to a value obtained by multiplying the current axial force value by the first ratio;
the first ratio is set based on the vehicle speed and the steered angle signal; and
the controller is configured to, in the virtual mode,
set the first ratio and the second axial force value to zero, and
set the vehicle speed for use in calculation of the first axial force value to a predetermined value.

8. The steering system according to claim 5, wherein:
the steering operation device includes a current sensor configured to detect the steering current;
the controller is configured to
receive an accelerator signal related to operation of an accelerator operation member for operating an accelerator provided to a vehicle, and a brake signal related to operation of a brake operation member for operating a brake provided to the vehicle, and
when calculating a virtual axial force value to be included in the operation reaction force,
calculate a current axial force value based on a detection value from the current sensor,
calculate an angle axial force value based on a sum of a first axial force value based on a vehicle speed and the target steered angle and a second axial force value corresponding to the operation reaction force when the vehicle speed is equal to or lower than a predetermined speed, and
by using a first ratio and a second ratio that are set to have a sum of 1, calculate the virtual axial force value by adding a value obtained by multiplying the angle axial force value by the second ratio to a value obtained by multiplying the current axial force value by the first ratio;
the first ratio is set based on the vehicle speed and the steered angle signal; and
the controller is configured to, in the virtual mode, set the vehicle speed for use in calculation of the first axial force value, the first ratio, and/or the second axial force value based on the accelerator signal or the brake signal.
